(19) United States
(12) Patent Application Publication
(10) Pub. No.: US 2005/0069089 A1
(43) Pub. Date: Mar. 31, 2005

(54) Apparatus and method for determining location of a source of radiation

(75) Inventors: Brian S. R. Armstrong, Shorewood, WI (US); Cindy R. Miller, Lincolnshire, IL (US)

Correspondence Address: Jamie H. Rose;Wolf, Greenfield & Sacks, P.C., 600 Atlantic Avenue, Boston, MA, 02210, US

(73) Assignee: GE Sensors, LLC, Sarasota, FL (US)

(21) Appl. No.: 10/895,020

(22) Filed: Jul. 20, 2004

Related U.S. Application Data
(60) Provisional application No. 60/489,238, filed on Jul. 23, 2003.

(51) Int. Cl. H05G 1/28; G01J 5/02

(52) U.S. Cl. 378/162

(57) ABSTRACT

An apparatus for determining location information associated with a source of radiation includes a generator configured to emit a pattern of radiation in response to radiation received from the source, and a radiation pattern sensor disposed in a substantially fixed orientation relative to the generator to sense the emitted pattern of radiation. The pattern of radiation has a least one intensity maximum characterized by a position that indicates a bearing of the source of radiation. A related method includes receiving radiation from a source of radiation, generating a pattern of radiation, and extracting data associated with the angular bearing of the source.

### RELATED APPLICATIONS

This application claims priority under 35 U.S.C. § 119(e) to U.S. Provisional Application Ser. No. 60/489,238, entitled “Retro-Grate Reflector For Linear Tomography,” filed on Jul. 20, 2003, which is herein incorporated by reference in its entirety.

### BACKGROUND OF INVENTION

1. Field of Invention

The invention generally relates to systems and methods for orientation determinations, and, more particularly, to systems and methods for determining a location of a source of radiation.

2. Discussion of Related Art

Computer Aided Tomography (CAT) is an x-ray-based technology for generating 3-D images. CAT is often performed with a CAT scanner, which is typically a specialized and expensive imaging tool. The typical scanner sweeps an x-ray tube and detector along a circular arc around a subject. Image data are collected with full 360° sweeps. The processed data provides the 3-D images.

Linear Tomography (also called tomosynthesis) can provide CAT 3-D imaging capability at lower cost than possible with a CAT scanner. Typically, Linear Tomography systems collect x-ray images by moving an x-ray tube through a range of positions to generate a series of images at a series of exposure angles relative to a fixed x-ray imager. Linear Tomography can be implemented with a modified conventional x-ray system as found, for example, in a small medical office. The image resolution is typically inferior to that provided by a CAT scanner, but can be acceptable where cost is a salient concern.

In Linear Tomography, the relative positions of the x-ray tube, the imager, and the subject should be known with high accuracy. Typically, the patient and the imager are stationary, while the x-ray tube is movable. Since the tube position should be known with high accuracy, either the tube position can be controlled with precision, or the tube position can be measured with high accuracy. Often, the former approach is employed, for example, via a precision motor-driven x-ray tube positioning apparatus. Such an apparatus, however, can increase system cost, as well as raise safety concerns due to the powered and automated movement of the x-ray tube.

A Linear Tomography system that relies on measurement of x-ray tube position can be smaller, less costly, and safer to operate than a motor-driven system. The required measurements, however, can be difficult to implement, and can provide less accuracy than available from a precision motorized system. Linear Tomography, and a great variety of other technologies, would benefit from improved apparatus and methods to determine the location of a source of x-ray or other radiation.

### SUMMARY OF INVENTION

The invention arises, in part, from the realization that a direction to a source of radiation can be determined by use of an apparatus that includes, in one embodiment, two components: a first component that generates a radiation pattern characterized by an intensity maximum whose position co-varies with angular bearing-related movement of the radiation source; and a second component that senses the pattern to permit extraction of bearing data by observing the position of the maximum. The pattern generating component produces the pattern in response to radiation received from the source, where the received radiation can be substantially uniform across the pattern generating component.

The sensing component, for example, an imager, can be attached to the pattern generating component, for example, a moire pattern generator, in a manner that fixes the relative position and/or orientation of the two components. The sensing component can be, for example, fixedly or slidably attached to the pattern generating component. The sensed position of the maximum can then co-vary with a change in bearing of the source of radiation relative to the two components. Information extracted from the sensed position can then provide information such as the bearing to the source of radiation.

Accordingly, in a first aspect, the invention features an apparatus for determining location information associated with a source of radiation. The apparatus includes a radiation pattern generator and a radiation pattern sensor disposed in a substantially fixed orientation relative to the generator. The generator can be attached, for example, in relatively close proximity, to the sensor. In response to radiation received from the source, the radiation pattern generator emits a pattern of radiation having an intensity maximum characterized by a position that indicates a bearing of the source of radiation relative to a coordinate system defined by the radiation pattern generator. The radiation pattern sensor senses the emitted pattern of radiation by, for example, imaging the pattern of radiation.

A variety of components can serve as a radiation pattern generator. For example, the generator can emit a pattern of radiation via reflection from a curved surface. Alternatively, the emitted pattern of radiation can be transmitted through the generator. In some embodiments of the invention, the radiation pattern generator includes a moire pattern generator. A distance between the moire pattern generator and the sensor can be less than a length of the moire pattern generator. The apparatus can further include a pattern analyzer configured to determine the position of the intensity maximum from the sensed emitted pattern of radiation.

In a second aspect, the invention features a method for determining location information associated with a source of radiation. The method includes receiving, at a first site, radiation from the source of radiation, generating, in response to the received radiation, a pattern of radiation having an intensity maximum characterized by a position that indicates a bearing to the source of radiation, and extracting, from the pattern of radiation, data associated with an angular bearing of the source relative to the first site.

The method can also include generating a second pattern of radiation from radiation received at a second site, extracting, from the second pattern, data associated with a second angular bearing of the source relative to the second site, and determining a distance to the source in response to the extracted bearing data.

In a third aspect, the invention features an x-ray tomography apparatus. The apparatus includes at least one x-ray source, an x-ray sensor, such as an x-ray imager that forms an image associated with x-rays received from the source, and a radiation pattern generator, such as a moire pattern generator, disposed adjacent to the sensor to determine a bearing angle to the x-ray source relative to the x-ray sensor.

A sensor can be moveable between at least two locations adjacent to the imager to obtain a distance of the x-ray source from the x-ray sensor. The apparatus can include additional pattern generators disposed adjacent to the x-ray sensor in a spaced relationship to obtain a distance of the x-ray source from the x-ray sensor. The x-ray sensor can be positioned to image a radiation pattern generated by the pattern generator.

If the x-ray sensor is an imager, the imager can be associated with an array of pixels, a first portion of the array of pixels imaging x-rays that pass through a subject, and a second portion of the array of pixels imaging the moire pattern generated by the moire pattern generator. The at least one source is moveable between at least two locations to direct x-rays toward a subject from at least two different directions. Alternatively, the at least one source can include at least two sources in a spaced relationship to direct x-rays toward a subject from at least two different directions.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an embodiment of an apparatus for determining location information associated with a source of radiation, according to principles of the invention.

FIG. 2A is a plan view of an embodiment of a moire pattern generator, according to principles of the invention.

FIG. 2B is an enlarged plan view of a portion of the moire pattern generator of FIG. 2A.

FIG. 2C is a side view of the moire pattern generator of FIG. 2A.

FIGS. 2D and 2E illustrate the position variation of an intensity maximum with bearing angle of a source for the generator of FIG. 2A.

FIG. 2F is a graph of radiation pattern intensity as a function of position corresponding to FIGS. 2D and 2E.

FIGS. 3A to 3C are, respectively, plan and side views of an embodiment of a moire pattern generator, according to principles of the invention.

FIG. 3D is a plan view of the first mask of the generator of FIGS. 3A and 3B.

FIG. 3E is a plan view of the second mask of the generator of FIGS. 3A and 3B.

FIG. 3F is a plan view of the superimposed masks of FIGS. 3A and 3B.

FIG. 4A is a side view of an embodiment of an apparatus that includes a radiation pattern sensor and a reflection-type radiation pattern generator, according to principles of the invention.

FIGS. 4B and 4C show the apparatus of FIG. 4A with a source at different bearing angles relative to the apparatus.

FIG. 5 is a flowchart of an embodiment of a method for determining location information associated with a source of radiation, according to principles of the invention.

FIG. 6 is a block diagram of an embodiment of an x-ray tomography apparatus, according to principles of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

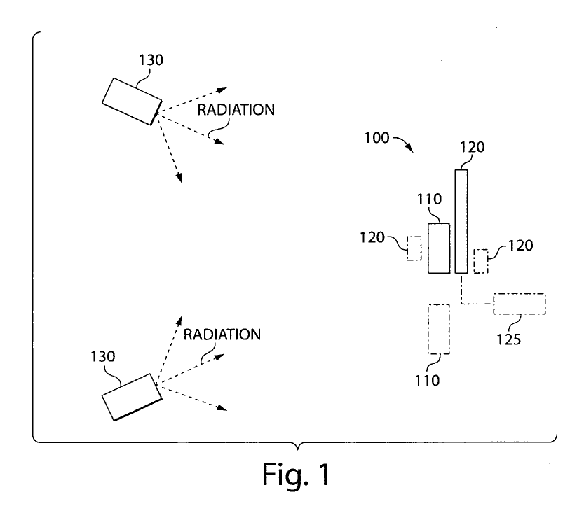

FIG. 1 is a block diagram of an embodiment of an apparatus 100 that can determine location information associated with a source of radiation; for illustrative purposes, the apparatus 100 is shown with a source of radiation 130. The apparatus 100 can be used with more than one source 130 (shown with dashed lines.)

The apparatus 100 includes a radiation pattern generator 110 and a radiation pattern sensor 120. The generator 110 is configured to emit, in response to radiation received from the source 130, a pattern of radiation having an intensity maximum characterized by a position that indicates a bearing of the source of radiation 130 relative to the generator 110. Determination of the bearing from the position of the intensity maximum is described in more detail below.

The radiation pattern sensor 120 is disposed to sense the pattern emitted by the generator 110. For example, the radiation pattern sensor 120 can be attached to the radiation pattern generator 110. The generator 110 preferably has a fixed rotational orientation relative to the sensor 120. Changes in the pattern may then arise solely from movement of the source 130 relative to the radiation pattern generator 110. The apparatus can include two or more generators 110, as shown, for example, in dashed lines, and can include two or more sensors 120, as shown, for example, in dashed lines.

The apparatus 100 can be used to track radiation sources that produce radiation having a wave nature. For example, the radiation can be electromagnetic radiation or acoustic radiation. Acoustic radiation can be associated with, for example, wave propagation in a solid, a liquid, and/or a gas. Thus, according to broad principles of the invention, an apparatus 100 can be used to determine a bearing angle of a source of radiation producing, for example, visible light, x-rays, under-water sound waves, or seismic waves arising from geologic activity.

An apparatus 100 can include additional radiation pattern generators 110 spaced from each other. The generators 110 may simultaneously provide two or more bearing angles to a source of radiation 130. Triangulation can then be performed to determine a distance from a generator 110 to the source 130. The radiation pattern generators 110 can be attached to the same or a different radiation pattern sensor 120. Alternatively, a radiation pattern generator 110 can be moveable between at least first and second sites to obtain triangulation data associated with the source of radiation 130.

The radiation pattern sensor 120 can be an imaging device, or other device configured to collect position dependent data from a pattern of radiation. For example, the radiation pattern sensor 120 can be a camera, an electronic-based imaging array, a sheet of film, or any of a variety of intensity measuring devices. The radiation pattern sensor 120 can be, for example, stationary and/or mechanically scanned to collect intensity data for the pattern of radiation.

Some embodiments of sensors 120, suitable for inclusion in the apparatus 100, include detector arrays or multi-element devices such as charge-coupled device (CCD) sensors. Other embodiments of suitable sensors 120 do not include discrete elements. Some of these embodiments provide continuous position data. For example, such a sensor 120 can include a position sensitive detector (PSD), also referred to as a position sensitive diode. A PSD can collect data from a pattern of radiation to permit determination of the position of an intensity maximum of the pattern, for example, the centroid of a bright spot of radiation.

A PSD typically includes a single substrate photodiode whose configuration permits locating a centroid of a radiation pattern within a sensing area. One type of PSD is a lateral-effect PSD, which, as will be understood by one having ordinary skill in the PSD arts, can measure intensity positions for a light pattern. For example, the closer a light centroid is to a particular terminal of the PSD, the larger the portion of current that flows through that lead. Comparison of various currents produced by the PSD can then determine the centroid position.

Some embodiments of the invention that utilize a PSD also include an optical color filter to reduce the effects of ambient light, which can swamp a relatively small signal derived from a radiation pattern. Additionally, for example, a sinusoidal carrier of higher frequency can be applied so that the PSD signal currents then vary sinusoidally at approximately the same frequency as the carrier, and can be demodulated to recover PSD currents that are substantially proportional to the radiation centroid.

In other embodiments of the invention, the sensor 120 includes an imager. An imager can be, for example, a lens-based device, such as a camera. Alternatively, an imager can be of a kind that collects radiation without a lens or other aperture. For example, a sensor 120 can include an imaging array of a similar or greater size than a radiation pattern generator 110. The sensor 120 can be disposed in close proximity to the radiation pattern generator 110.

Thus, depending on the type of radiation of interest, the sensor 120 can be based on, for example, an array-type detector including, for example, detector diodes for microwave radiation, one or more CCD's for infrared or visible radiation, an imaging x-ray detector for x-rays, or an array of piezo-electric detectors for acoustic waves.

Depending on the type of generator 110, the emitted pattern of radiation can be, for example, reflected from or transmitted through the generator 110. As described in more detail below, a generator 110 can include, for example, a moire pattern generator and/or an orientation dependent reflector. The generator 110, in response to radiation received from the source 130, can emit a bright spot whose position co-varies with the bearing angle to the source 130, as perceived by the sensor 120.

The apparatus 100 can further include a radiation pattern analyzer 125 configured to determine the position of one or more intensity maxima from the sensed pattern of radiation. The pattern analyzer 125 may include software, firmware and/or hardware components. The software may be designed to run on general-purpose equipment or specialized processors dedicated to the functionality herein described.

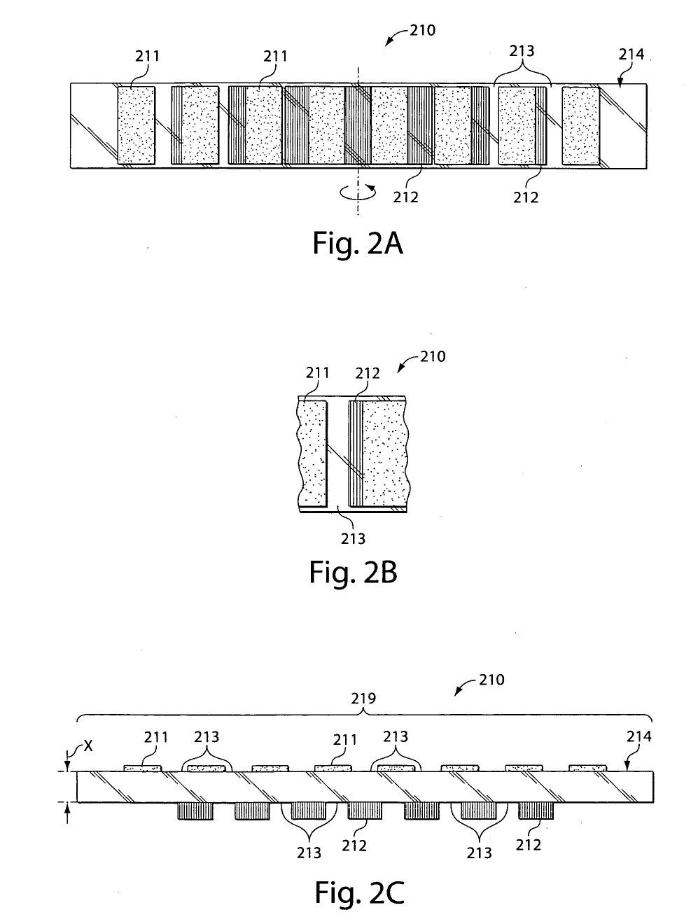

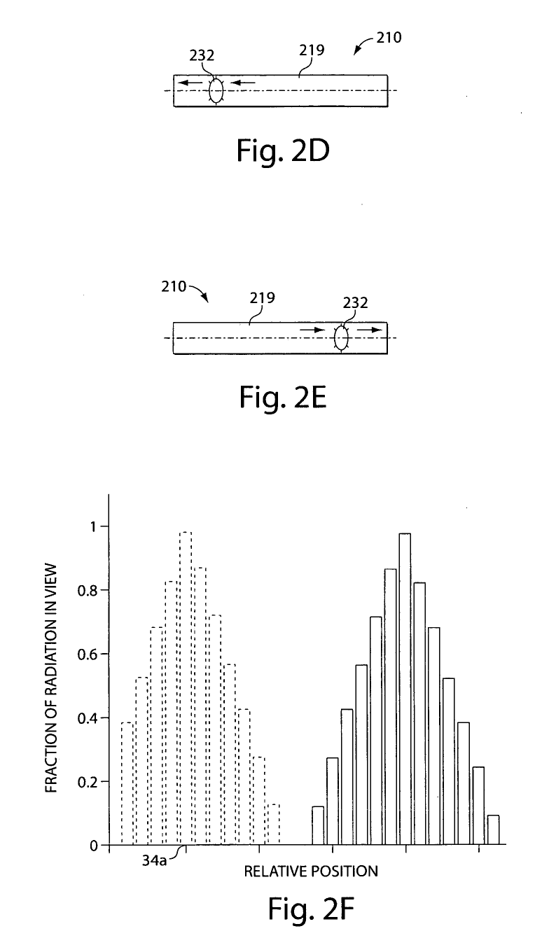

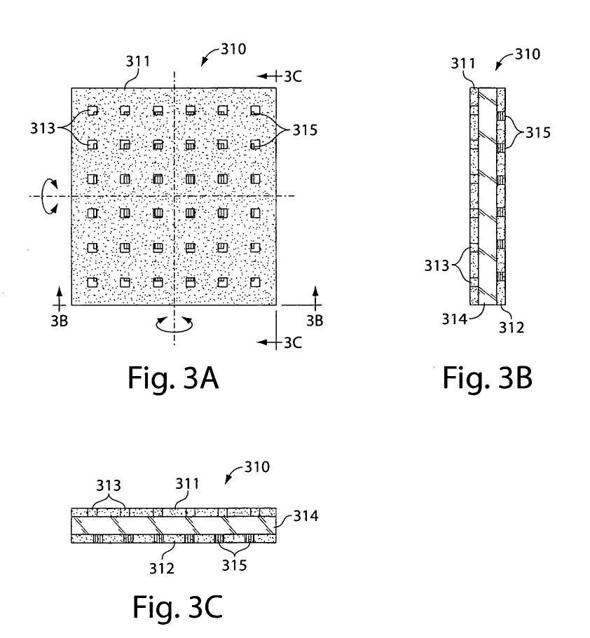

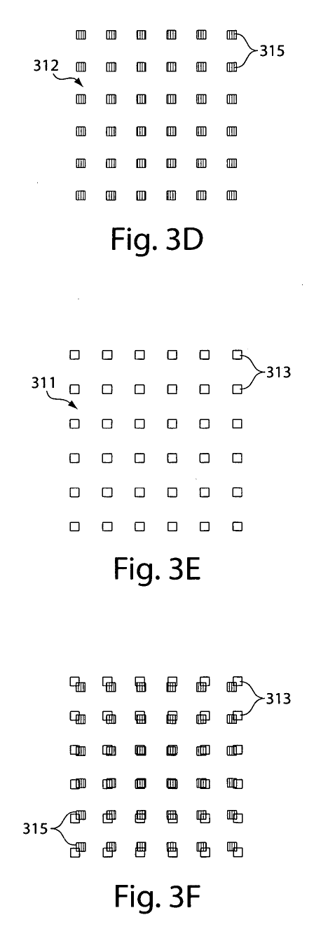

Now referring to FIGS. 2A to 2F and 3A to 3F, some examples of moire pattern generators that can be used as a radiation pattern generator 110 are described.

FIG. 2A is a plan view of an embodiment of a moire pattern generator 210, according to principles of the invention. The moire pattern generator 210 can be used as a radiation pattern generator 120 in the apparatus 100 described above. FIG. 2B is an enlarged plan view of a portion of the moire pattern generator 210, while FIG. 2C is a side view of the moire pattern generator 210.

The moire pattern generator 210 includes a first mask 211 and a second mask 212, each of which has portions that substantially block radiation from a source. In the figures, the first mask 211 is generally indicated as areas filled with dots, and the second mask 212 as filled with lines. The generator 210 may also include a support structure 214 disposed between and supporting the masks 211, 212. The radiation from a source, as discussed above, may be, for example, either acoustic or electromagnetic in nature, and may have a variety of wavelength ranges of interest, for example, ultrasound, infrared, visible, ultraviolet, x-ray, etc.

The masks 211, 212 may be made of a variety of materials that at least partially absorb, or do not fully transmit, a particular wavelength range or ranges of a source. Examples of first mask materials, suitable for purposes of the invention, include, but are not limited to, any number of acoustic and/or electromagnetic absorbers having a variety of physical sizes and forms. In particular, for embodiments of the invention in which the generator 210 may be fabricated using conventional semiconductor fabrication techniques, first mask materials suitable for purposes of the invention may include a variety of thin films which at least partially absorb, or do not fully transmit, the source radiation.

The first mask 211 or second mask 212, depending on the viewing direction of a sensor, defines an observation surface 219 of the generator 210, i.e., a sensor, such as the sensor 120, observes radiation emitted from the defined surface. Each mask 211, 212 also defines a number of openings 213 through which the source radiation can pass.

The support structure 214 is preferably transparent to the radiation of interest. The support structure 214 may be formed from a solid material that allows substantially undistorted transmission of the source radiation. The first mask 211 may include a continuously connected piece of mask material, or separate pieces of mask material, formed on the support structure 214. The second mask 212 may have a similar structure.

The openings 213 of the masks 211, 212 are offset relative to each other such that substantially uniform radiation passing through the generator 210 is emitted with an observable intensity maximum whose centroid varies in position as the angular bearing to the source varies. The radiation pattern emitted from the observation surface 219 of the moire pattern generator 210 may include more than one maxima and associated centroids. A relationship between the observed position of the centroid and a bearing angle can be determined, for example, either empirically of theoretically. In one empirical approach, a source can be moved through different known bearing angle locations while observing the corresponding position of the intensty maximum. A theoretical relationship between centroid position and bearing angle can be developed from the geometry and dimensions associated with the generator 210, as will be understood by one having ordinary skill in the relevant arts. For example, the bearing angle is generally a function of the particular opening sizes and spacing between the masks 211, 212. Some related theoretical relationships regarding mask configurations, in particular, the relationship between the position of an intensity maximum and the angle of masks relative to a source, are disclosed in International Patent Publication WO 01/35054 to Armstrong and Schmidt. In view of the instant Detailed Description, it will be apparent how to modify the theoretical relationships described therein to obtain theoretical relationships relevant to use of the instant generator 210.

The second mask 212 is separated from the first mask 211 by a distance X, which, as shown in the figures, may correspond to a thickness of the support structure 214. The region between the first mask 211 and the second mask 212 may be occupied by, for example, a gas, liquid, or solid which is substantially transmissive of the source. In particular, the support structure 214 may be a solid substrate which is transmissive of the source radiation, as discussed above. The first mask 211 may be coupled to a front surface of the support structure 214, while the second mask 212 may be coupled to a back surface of the support structure 214. In one embodiment, whether the support structure 214 is frame-like, trellis-like, or a transparent substrate, the second mask 212 may be arranged substantially parallel to the first mask 211, although other embodiments do not require this.

Additionally, in one embodiment of the invention, the distance X may be variable. For example, one or both of the masks 211, 212 may be coupled to a translational controller. The translational controller may serve as the support structure 214 itself, or may be coupled to the support structure 214. The translational controller may be operated to vary the distance X between the first and second masks.

With reference to FIGS. 2D, 2E, and 2F, the functioning of the moire pattern generator 210 may be described as follows. Viewing the observation surface 219, the openings 213 of the first mask 211 are offset relative to the openings 213 of the second mask 212, which is located behind the first mask 211 as illustrated in FIG. 2A.

FIGS. 2D and 2E illustrate the position variation of an intensity maximum with bearing angle to a source. Depending on the bearing angle to the radiation source, only some portions of the generator 210 permit radiation to pass through aligned openings 213. Moreover, the portions of the generator 210 having properly aligned openings varies with angular position of the source. The moiré pattern generator 210 thus produces a radiation pattern, on the observation surface 219, that includes one or more centroids 232, or maximum intensity radiation spots, as shown in FIGS. 2D and 2E. As the radiation source revolves about a bearing axis, openings of the masks 211, 212 that are aligned to permit radiation to pass cause the one or more centroids 232 to shift in position across the observation surface 219. Accordingly, by observing the position of the one or more centroids 232 along the generator's observation surface 219, the bearing angle may be determined.

FIG. 2F is a graph of radiation pattern intensity as a function of position as observed on the observation surface 219 illustrated in FIGS. 2D and 2E. The graph shows graphical representations of a radiation pattern in view from the observation area 219, including the centroids 232a and 232b produced by the generator 210 for two different bearing directions to a source. The graph of the intensity peak shown in FIG. 2D is indicated in FIG. 2F by dashed lines, while the graph of the peak shown in FIG. 2E is indicated in FIG. 2F by solid bar lines.

For each bearing angle of the radiation source relative to an apparatus 100 that includes the moire pattern generator 210, a specific radiation pattern having one or more detectable centroids 232 is produced at the observation surface 219 of the generator 210. The number of detectable centroids 232 for a given bearing angle is related to the manner in which the openings 213 and 215 of the first and second masks 211 and 212, respectively, are offset from each other, and the overall dimensions of the generator 210.

The generator 210 can be configured so that the moiré pattern repeats, for example, with every 3 degrees of bearing angle change. That is, for example, a repeat distance between intensity maxima of the pattern can correspond to a 3 degree shift in bearing angle. Within one repeat distance, the position of the intensity maximum of that repeat distance indicates the bearing angle. More than one of the maxima can be measured to improve accuracy. A coarse bearing can first be determined to determine in which 3 degree range of angles a bearing angle lies.

A coarse bearing angle, or range of angles, may be determined, for example, by placing a sufficiently radiation absorbing feature on a radiation generator 210 face nearest to a source. The position of the feature's shadow on, for example, an imager-type radiation sensor, or, for example, on a second of two PSD's, can indicate the coarse bearing angle.

In another embodiment of the invention, a second radiation generator 210 is used to generate at least a second intensity maximum, where the combined positions of the intensity maxima from the two generators 210 can uniquely indicate the bearing angle. The second radiation generator 210 can be provided with masks 211, 212 having, for example, different spacings than spacings of the masks 211, 212 of the first generator 210.

In some embodiments of the generator 210, the masks 211, 212 have grating spatial frequencies and duty cycles chosen to provide a selected number of intensity maxima on the observation surface 219, and the rate and direction of movement of the pattern in correspondence to changes of the bearing angle. The grating can be chosen, for example, to provide a desired level of precision of bearing angle determinations.

While the generator 210 shown in FIG. 2A has a substantially elongated shape, a generator 110 according to various embodiments of the invention may have a number of geometric shapes and sizes, depending at least in part on the application for which the generator 110 is used.

For example, a generator 110 according to one embodiment of the invention may be as small as a quarter, and may be fabricated using conventional semiconductor fabrication techniques. According to other embodiments of the invention, a generator 110 may be as large as a conventional billboard; or much larger for seismically generated acoustic radiation. Additionally, a generator 110 may have a substantially rectangular or square-shaped observation surface. Similarly, according to other embodiments, the observation surface may have a circular or elliptical shape. Moreover, a generator 110 may have a curved shape, and may be spherically or elliptically volumetric in form.

In some embodiments of an apparatus 100, the generator 110 is a sound pattern generator. In one such embodiment, the generator 110 is used to create a sound radiation pattern from acoustic radiation arriving from a fired weapon, such as a rifle. Though a desired size of a generator can be related to the wavelength radiation emitted by a source, the “crack” of a fired rifle can provide sound waves of a relatively short wavelength.

One embodiment of an apparatus for determining location information for a source of acoustic radiation, such as a weapon, according to principles of the invention, includes at least one radiation pattern generator and at least one associated radiation sensors. The generators and sensors can be arranged, for example, a view of 360°. Each of the acoustic pattern generators can be formed of a grating of acoustically absorbing material, which can be supported, for example, on a frame. The sensors can include, for example, piezo-electric detectors.

With reference to FIGS. 3A to 3C, a moire pattern generator may include masks having, for example, 2-D patterns rather than the 1-D pattern described above. FIGS. 3A to 3C are plan and side views of an embodiment of a moire pattern generator 310, according to principles of the invention. The generator 310 includes a first mask 311, a second mask 312, and a support structure 314 disposed between the two masks 311, 312.

Each mask 311, 312 defines openings 313, 315, respectively, through which radiation from a source may pass. In FIG. 3A, the openings 313 in the first mask 311 can be seen to be in the form of a first two-dimensional pattern. Similarly, the openings 315 in the second mask 312 are in the form of a second two-dimensional pattern, with, however, different spacings than for the first mask 311.

The generator 310 can support the determination of radiation source bearing in two dimensions, for example, relative to the two bearing axes illustrated in FIG. 3A. The generator 310 shown in FIGS. 3A to 3C may be similarly constructed and assembled as the generator 210 discussed above in connection with FIGS. 2A to 2F.

To more clearly illustrate the relationship between the two sets of openings 313, 315, the first mask openings 313 are shown as empty rectangles, while the second mask openings 315 appear as rectangles enclosing a series of vertical lines. It should be appreciated that this method of illustrating the second mask 312 and the openings 315 is different from that of FIGS. 2A to 2F, in which the radiation blocking portions of the first mask 212 are indicated by areas filled with vertical lines. Notwithstanding the different notation, the openings 315 and 313 of the first and second masks 311, 312 are arranged similarly to those of the generator 210 shown in FIGS. 2A to 2F, such that surface areas of the moire pattern generator 310 exposed through the openings 315 and 313 vary with the bearing of a radiation source about either the horizontal axes. For a particular bearing, an bearing dependent radiation pattern is produced on the observation surface having one or more detectable centroids that vary in position across the observation surface in two dimensions, corresponding to the bearing of the radiation source.

The offset nature of the openings 315 relative to the openings 313 may also be observed in the side views of FIGS. 3B and 3C. FIGS. 3D to 3F serve to clarify the relative positions of the openings 315, 313. FIG. 3D shows the second mask 312, FIG. 3E shows the first mask 311, and FIG. 3F shows the masks, 311, 312 superimposed.

It should be appreciated that a variety of geometric shapes and dimensions may be suitable for both the observation surface of the generator 310, as well as the openings 313, 315 of the two-dimensional pattern. The selection of geometric shape and dimension for any of the foregoing parameters, including the arrangement of openings 313, 315 in the patterns, may be dictated at least in part by the application for which the apparatus 100 according to the invention is used. For example, as discussed above, the observation surface may have a rectangular, circular or elliptical shape. Furthermore, the patterns, including the shapes and positions of the openings 313, 315 may be configured such that a first sensitivity of the position of one or more radiation centroids along one axis based on a bearing of a radiation source is greater than a second sensitivity of the position of the one or more centroids along a perpendicular axis.

As will be understood by one having ordinary skill in the wave propagation arts, preferred dimensions of the features of the masks 211, 212, 311, 312 of the generators 210, 310 can be determined, at least in part, in response to a wavelength of a source radiation. Preferred materials for the masks 211, 212, 311, 312, as well as a preferred construction of the support structures 214, 314, can be determined, at least in part, by the nature and wavelength of the radiation.

Furthermore, as will be understood by one having ordinary skill in the wave propagation arts, the details of the emitted radiation pattern will be influenced by diffraction and in some cases refraction as the radiation propagates through a mask, 211, 212, 311, 312, the support structure, 214, 314, and the second mask, 211, 212, 311, 312.

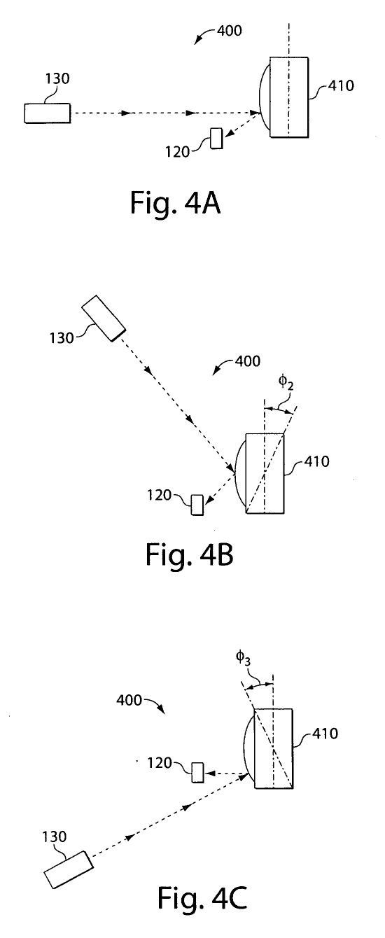

Now referring to FIGS. 4A to 4C, in some embodiments of the invention, a radiation pattern generator 110 includes an orientation dependent reflector that does not entail generation of a moire pattern. FIG. 4A is a side view of an embodiment, according to principles of the invention, of an apparatus 400 that includes a radiation pattern sensor 120 and a specular-dome reflector 410 acting as a radiation pattern generator. The sensor 120, as shown, can be attached to the reflector 410. A source 130 is illustrated at a location with a bearing angle of zero relative to the apparatus 400. FIGS. 4B and 4C show the apparatus 400 with the source 130 at different bearing angles φ₂, φ₃ relative to the apparatus 400.

The specular-dome reflector 410 provides a reflection of radiation arriving from the source 130, for example a beam of light. The reflected radiation, as perceived by the sensor 120, has a centroid of intensity whose position varies with variation in the bearing to the source 130. In this embodiment, only one centroid of reflection is detected at a time, corresponding to a specific angular bearing to the source.

Some other examples of orientation dependent devices that do not entail moire patterns, as well as some that do entail moire pattern creation, are described in U.S. Pat. Nos. 5,936,722, 5,936,723, and 6,384,908, all to Schmidt and Armstrong, and International Patent Publication WO 01/35054, inventors Armstrong and Schmidt, all of which are incorporated herein by reference. In view of the disclosure contained herein, one having ordinary skill in the direction finding arts will understand how to modify the devices described in these references according to principles of the invention.

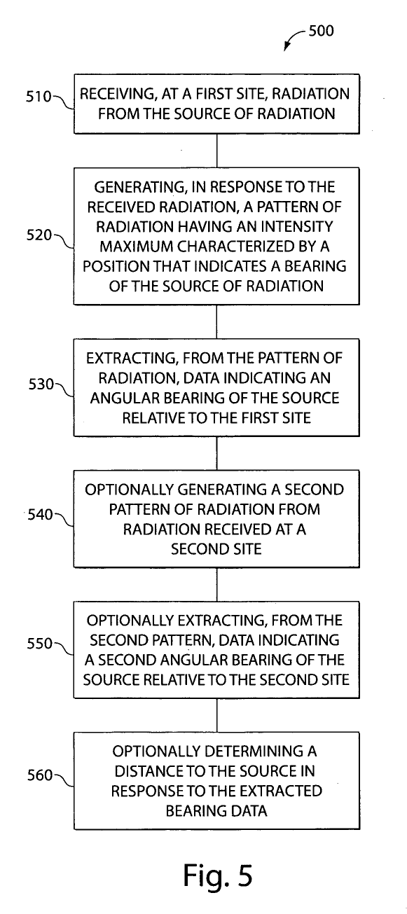

FIG. 5 is a flowchart of an embodiment of a method 500 for determining location information associated with a source of radiation, according to principles of the invention. The method 500 can be implemented, for example, with the apparatus 100 illustrated in FIG. 1. The method 500 includes the step 510 of receiving, at a first site, radiation from the source of radiation, the step 520 of generating, in response to the received radiation, a pattern of radiation having an intensity maximum characterized by a position that indicates a bearing to the source of radiation, and the step 530 of extracting, from the pattern of radiation, data associated with an angular bearing of the source relative to the first site. In some embodiments of the method 500, the pattern of radiation is associated with a moire pattern.

The method 500 optionally includes the step of 540 generating a second pattern of radiation from radiation received at a second site, the step 550 of extracting, from the second pattern, data associated with a second angular bearing of the source relative to the second site, and/or the step 560 of determining a distance to the source in response to the extracted bearing data.

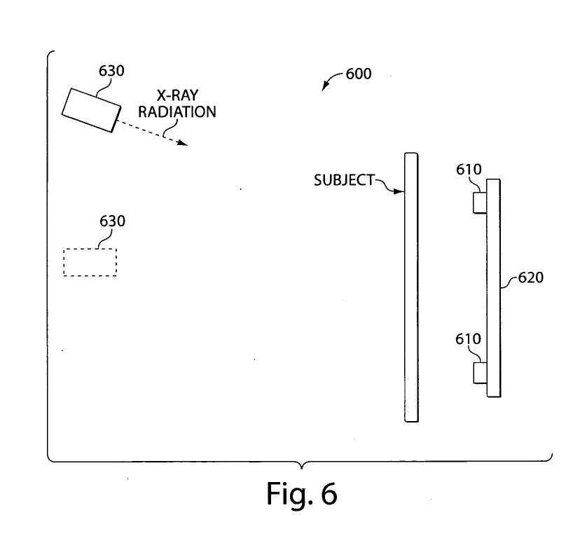

FIG. 6 is a block diagram of an embodiment of a x-ray tomography apparatus 600, according to principles of the invention. The tomography apparatus includes at least one x-ray source 630, an x-ray imager 620 that forms an image associated with x-rays received from the source 630, and at least one moire pattern generator 610 disposed adjacent to the imager 620 to determine a bearing of an x-ray source 630 relative to an x-ray imager 620. A moire pattern generator 610 can include a first grating and a second grating spaced from the first grating. The generator 610 can be constructed like the generators 210, 310 described above.

The x-ray source 630 can be movable and/or the apparatus can include two or more sources 630 (as indicated with dashed lines) to permit collection of images for two or more different bearings of a source 630 relative to the generator 610 and the imager 620. Thus, a source 630 can be fixed or moveable between at least two locations to direct x-rays toward a subject from at least two different directions. The apparatus 600 can include two or more sources 630 in a spaced relationship to direct x-rays toward a subject from two or more directions.

The moire pattern generator 610 can be moveable and/or the apparatus 600 can include two or more moire pattern generators 610 to obtain a distance of the x-ray source from the x-ray imager. For example, a more pattern generator 610 may be movable between at least two locations adjacent to the imager 620 to collect bearing data of the source 610 at the at least two sites of the generator 610. The data can support triangulation calculations to permit, for example, determination of a distance of the source 610 from the imager 620.

Two moire pattern generators 610, for example, can be disposed in a spaced relationship adjacent to an imager 620, for example, at opposite ends of the imager 620, as illustrated. Moreover, the x-ray imager 620 can be positioned to image moire patterns generated by the moire pattern generators 610.

In some embodiments, according to principles of the invention, the x-ray imager 620 is used to image both the subject and a moiré pattern produced by the moiré pattern generator 610. In these embodiments, one or more pattern generators 610 can be placed between the source 630 and the imager 620. If the imager 620 includes an array of pixels, for example, a first portion of the array of pixels can image x-rays that pass through a subject, and a second portion of the array of pixels can image the moire pattern generated by the moire pattern generator. For example, if the imager 620 is a pixel-based digital imager having pixels of about 1 mm by 1 mm, a moire pattern generator 610 can be placed in front of a portion of the imager 620 having, for example, about 40 by 40 pixels. Thus, a moiré pattern can be imaged with sufficient resolution to extract intensity maxima data, and the remaining portions of the imager can be large enough to effectively image a subject.

The x-ray imager 620 can be an electronic x-ray imager having an array of pixels each including a scintillating crystal and photon detector, as known to one having ordinary skill in the x-ray arts. The imager 620 can, for example, include a crystal which converts x-rays to lower-energy photons of approximately optical wavelengths. The crystal material may be selected to determine the wavelength of emitted light. The x-ray imager 620 can utilize, for example, film, fluoroscopy, and/or digital radiography, as known to one having ordinary skill in the x-ray imaging arts. For example, the x-ray imager 620 can be a digital imager that directly or indirectly provides quantitative intensity data associated with an array of image pixels. A digital imager 620 can include, for example, a phosphor screen or solid state components. The digital imager 620 can produce an electric signal in response to absorbed x-rays.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. An x-ray tomography apparatus, comprising:
at least one x-ray source;
an x-ray sensor that forms an image associated with x-rays received from the source; and
at least one radiation pattern generator disposed adjacent to the sensor to determine a bearing angle of the x-ray source relative to the x-ray imager.

2. The apparatus of claim 1, wherein the at least one radiation pattern generator comprises at least one moire pattern generator.

3. The apparatus of claim 1, wherein the at least one radiation pattern generator is moveable between at least two locations adjacent to the imager to obtain a distance of the x-ray source from the x-ray imager.

4. The apparatus of claim 1, wherein the at least one radiation pattern generator comprises at least two radiation pattern generators disposed adjacent to the imager in a spaced relationship to obtain a distance of the x-ray source from the x-ray imager.

5. The apparatus of claim 1, wherein the x-ray sensor comprises an imager positioned to image a radiation pattern generated by the radiation pattern generator.

6. The apparatus of claim 5, wherein the x-ray sensor is associated with an array of pixels, a first portion of the array of pixels imaging x-rays that pass through a subject, and a second portion of the array of pixels imaging the radiation pattern generated by the radiation pattern generator.

7. The apparatus of claim 1, wherein the at least one source is moveable between at least two locations to direct x-rays toward a subject from at least two different directions.

8. The apparatus of claim 1, wherein the at least one source comprises at least two sources in a spaced relationship to direct x-rays toward a subject from at least two different directions.

9. The apparatus of claim 1, wherein the radiation pattern generator comprises a first grating and a second grating spaced from the first grating.

10. An apparatus for determining location information associated with a source of radiation, comprising:
a radiation pattern generator configured to emit, in response to radiation received from the source, a pattern of radiation having an intensity maximum characterized by a position that indicates a bearing angle of the source of radiation; and
a radiation pattern sensor disposed in a substantially fixed orientation relative to the generator to sense the emitted pattern of radiation.

11. The apparatus of claim 10, wherein the radiation pattern sensor is attached to the radiation pattern generator.

12. The apparatus of claim 10, wherein the emitted pattern of radiation is reflected from the radiation pattern generator.

13. The apparatus of claim 10, wherein the emitted pattern of radiation is transmitted through the radiation pattern generator.

14. The apparatus of claim 10, wherein the radiation pattern generator comprises a moire pattern generator.

15. The apparatus of claim 14, wherein a distance between the moire pattern generator and the sensor is less than a length of the moire pattern generator.

16. The apparatus of claim 14, wherein the moire pattern generator comprises a first patterned mask and a second second patterned mask spaced from the first patterned mask.

17. The apparatus of claim 16, wherein the first patterned mask comprises a two-dimensional grating.

18. The apparatus of claim 14, wherein the moire pattern generator is configured to generate a moire pattern from acoustic radiation received from the source of radiation, and the radiation pattern sensor is configured to sense the moire pattern of acoustic radiation to determine the bearing angle of the source of acoustic radiation.

19. The apparatus of claim 18, wherein the source of acoustic radiation is at least one fired weapon.

20. The apparatus of claim 10, further comprising a pattern analyzer configured to determine the position of the intensity maximum from the sensed emitted pattern of radiation

21. The apparatus of claim 10, wherein the pattern of radiation has a plurality of intensity maxima characterized by a plurality of positions, at least one of the maxima indicating the bearing angle of the source of radiation.

22. The apparatus of claim 10, wherein the radiation pattern sensor comprises an imager that collects an image of the emitted pattern of radiation.

23. The apparatus of claim 10, wherein the radiation pattern sensor comprises an array of sensors.

24. The apparatus of claim 10, wherein the radiation has a wave characteristic.

25. The apparatus of claim 24, wherein the radiation is one of electromagnetic radiation and acoustic radiation.

26. The apparatus of claim 25, wherein the acoustic radiation is associated with seismic waves.

27. The apparatus of claim 10, further comprising a second radiation pattern generator spaced from the radiation pattern generator to provide a second bearing angle of the source of radiation.

28. The apparatus of claim 27, wherein the second radiation pattern generator is attached to one of the radiation pattern sensor and a second radiation pattern sensor.

29. The apparatus of claim 10, wherein the radiation pattern generator is moveable between at least first and second sites to obtain triangulation data associated with the source of radiation.

30. A method for determining location information associated with a source of radiation, comprising:
receiving, at a first site, radiation from the source of radiation;
generating, in response to the received radiation, a pattern of radiation having an intensity maximum characterized by a position that indicates a bearing angle of the source of radiation relative to the first site; and
extracting, from the pattern of radiation, data associated with the bearing angle of the source.

31. The method of claim 30, wherein the pattern of radiation is associated with a moire pattern.

32. The method of claim 30, further comprising generating a second pattern of radiation from radiation received at a second site, extracting, from the second pattern, data associated with a second bearing angle of the source relative to the second site, and determining a distance to the source in response to the extracted bearing data.

33. The apparatus of claim 30, wherein the radiation is one of electromagnetic radiation and acoustic radiation.
